(19) United States
(12) Patent Application Publication
(10) Pub. No.: US 2002/0126479 A1
(43) Pub. Date: Sep. 12, 2002

(54) High power incoherent light source with laser array

(75) Inventors: Jinhui Zhai, Plano, TX (US); Wenhui Mei, Plano, TX (US); Kin Foong Chan, Plano, TX (US)

Correspondence Address: HAYNES AND BOONE, LLP, 901 MAIN STREET, SUITE 3100, DALLAS, TX, 75202, US

(73) Assignee: Ball Semiconductor, Inc., Allen, TX (US)

(21) Appl. No.: 09/683,971

(22) Filed: Mar. 7, 2002

Related U.S. Application Data
(60) Provisional application No. 60/274,371, filed on Mar. 8, 2001.

(51) Int. Cl. F21V 33/00; F21S 2/00; G02B 6/00; G02B 5/32

(52) U.S. Cl. 362/244; 345/32; 362/227; 362/234; 359/20; 359/15; 385/147

(57) ABSTRACT

A high power light source is provided. The light source includes one or more diodes that may produce relatively coherent light of a desired intensity. The diodes may be pulsed to provide light as desired. The light projected by the diodes passes through a combiner, which combines the light from the different diodes and passes the combined light to an incoherence apparatus. The incoherence apparatus may include a rotating surface relief phase device such as an optical hologram, a computer generated hologram, or a diffractive optical element with random phase modulation. The incoherence apparatus may include a rotating fiber conduit comprising a plurality of multifiber cores. The incoherence apparatus renders the combined light incoherent and passes it to an illuminator apparatus that focuses the incoherent combined light onto an image plane.

### CROSS REFERENCE TO RELATED APPLICATIONS

This application claims the benefit of U.S. Provisional Application No. 60/274,371, filed on Mar. 8, 2001.

### BACKGROUND

This disclosure relates generally to incoherent light sources, such as can be used in display systems and/or photolithography exposure systems.

In conventional display and photolithography exposure systems, an image source is required for exposing an image onto a subject. With photolithography systems, the subject may be a photo resist coated semiconductor wafer for making integrated circuits, a metal substrate for making etched lead frames, or a conductive plate for making printed circuit boards. With display systems, the subject may be a display screen, such as is used by a projector. For the sake of the present discussion, display systems and exposure systems will be collectively discussed as “imaging systems,” unless otherwise noted.

With reference now to FIG. 1, a conventional imaging system 10 includes a light source 12 that projects light through or onto an image source 14. Common image sources in analog systems include masks and reticles. Common image sources in digital systems include pixel panels such as a deformable mirror device (DMD), a liquid crystal display (LCD), or a spatial light modulator (SLM). A resulting image is then projected onto a subject 16. The system 10 may also include one or more lens systems 18, 20 for directing and focusing the light and image, accordingly.

To increase the image resolution, and decrease the minimum line and space widths, it may be desirable that the light source 12 provide light in short wavelengths, such as in the ultra(UV) or deep ultra(DUV) range. For example, Xenon and Mercury arc lamps in the UV range and Krypton(KrF) and Argon(ArF) gas lasers in the DUV range are commonly used. However, these light sources have significant disadvantages. For one, they are very expensive. Also, they are large and inefficient. Further, there are many maintenance and safety concerns in these light sources.

Some applications, such as photolithography, suffer from further disadvantages. For example, the Mercury arc lamps are a broadband light source. Often photolithography uses a filtered bandwidth of light, so that the remaining light is unused. The filtered bandwidth has very low energy and arc lamps can only be maintained for several thousand hours before replacement is required. Also, an arc lamp source is an extended light source with an arc gap length about 4 millimeters (mm), compared with a point light source such as a laser, which will affect the performance of a scanning micro-lens array exposure system.

Therefore, certain improvements are desired for imaging systems. For one, it is desirable to provide a high power incoherent light source that produces light of a desired intensity. In addition, it is desired to provide high light energy efficiency, to provide high productivity, and to be more flexible and reliable.

### SUMMARY

A technical advance is provided by a novel light source and method for projecting light onto a subject. In one embodiment, the light source comprises a diode array for producing one or more individual laser lights, where the diode array includes at least one diode. The light source also includes a combiner for combining the laser lights, an incoherence apparatus for rendering the combined laser light incoherent, and an illuminator apparatus for focusing the incoherent combined light onto an image plane.

In another embodiment, the light source includes a pulse source for pulsing the diodes of the diode array at a high frequency.

### BRIEF DESCRIPTION OF DRAWINGS

FIG. 1 is a block diagram of a conventional imaging system.

FIG. 2 illustrates an exemplary high power incoherent light source.

FIG. 3 illustrates an incoherence apparatus that may be utilized in the light source of FIG. 2.

FIG. 4 illustrates a fiber conduit that may be utilized in the light source of FIG. 2.

FIG. 5 illustrates multiple optic fibers from the fiber conduit of FIG. 4.

FIG. 6 illustrates an incoherence apparatus utilizing a liquid crystal medium.

FIGS. 7-11 illustrate a variety of component combinations that may be used to form a light source.

FIGS. 12 and 13 illustrate embodiments of a diode display system.

### DETAILED DESCRIPTION

The present disclosure relates to light sources, and more particularly, to a high power incoherent light source using an array of solid-state lasers. The light source can be used in imaging systems, such as are discussed above, as well as other similar applications. It is understood, however, that the following disclosure provides many different embodiments, or examples, for implementing different features of the invention. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Solidlasers, such as an ultra violet (UV) laser diode, have many merits, including high energy efficiency, narrow spectral width, high frequency modulation, easy power control, compact size, and longer life time. In addition, the UV laser diode is very reliable and inexpensive.

Conventionally, however, solid-state diodes also have many disadvantages. One disadvantage of the laser diode light source is that it may result in coherent laser noise. The UV laser diode emits a highly spatially coherent beam. While the coherent beam is advantageous in other applications, it may cause problems in photolithography and display systems. For example, when a coherent beam is expanded or otherwise optically processed to provide even illumination for an image source, spatially random interference patterns or “speckle” may occur in the image plane. Such nonare unacceptable for imaging applications. For example, with photolithography, these interference patterns may create correspondingly unevenly exposed regions on the subject being exposed.

Another disadvantage of the laser diode light source is that it provides only a small amount of light power from one unit. Laser diodes usually provide several tens of milliwatts (mW) of light power. However, in photolithography, especially for a relatively large area printed circuit board (PCB) exposure, more than 100 mW of power may be needed from the light source.

The present disclosure provides methods and apparatuses for efficiently combining the light power of multiple laser diodes into a high power light source, and eliminating the coherence noise of laser diodes for uniform illumination, such as can be used in imaging systems. It is noted that various embodiments and/or components described below may be used in many different combinations.

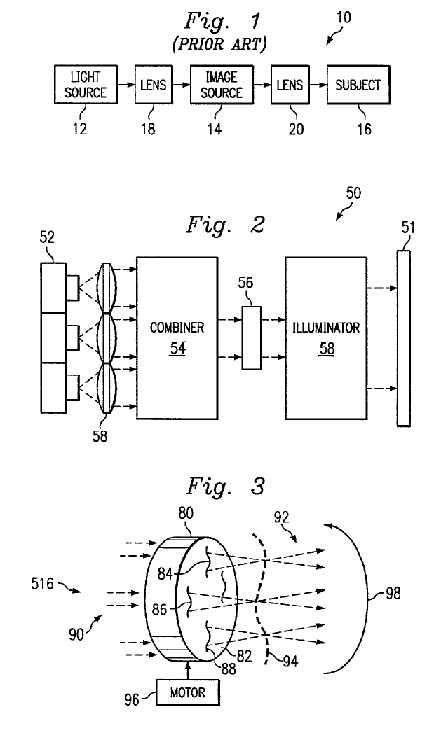

Referring now to FIG. 2, in one embodiment, a new and improved light source 50 can be used in many applications, including the imaging system 10 of FIG. 1. The light source 50 will produce an illumination plane 51 that, in the example of FIG. 1, corresponds with the surface of the image source 14. The light source 50 includes a laser array source 52, a laser power combiner 54, an apparatus for laser light incoherence 56, and an illuminator 58 for uniform illumination. The laser array source 52 may be a combination of one or more discrete laser diodes, such as a verticalsurface emitting lasers (VCSELs) array or other laser array sources.

The laser power combiner 54 may be a fiber bundle, a fly's eye array/condenser configuration, fiber conduits or a fiber taper, discussed in greater detail below. The incoherence apparatus 56 may be a rotating surface relief phase modulator, rotating fiber conduits, a liquid crystal phase modulator or an electrophase array modulator and differential optical delay optic. The light illuminator 58 may be a beam collimating system, an expander system or a Köhler illumination system. In the present example, a lens system 58 may be utilized to collimate and/or shape light projected by the laser diode array 52.

In order to combine the light power from laser diode array 52, various methods are known, including the use of multias described in U.S. Pat. Nos. 6,167,075, 5,580,471, and 5,579,422, which combine light power from a laser array for an optical fiber pumping system in a lightwave communication systems, for material treatment and inspection, and for coupling into a multimode optical fiber. However, there is no discussion of speckle reduction for uniform illumination.

Various methods are known for speckle reduction from coherent laser light, including speckle reduction by a combination of temporal division and spatial aberration, as described in U.S. Pat. No. 6,191,877; the use of spinning diffuser plates or flowing fluid diffusers, as described in U.S. Pat. No. 6,154,259 and 5,990,983; a differential optical delay, as described in U.S. Pat. No. 6,169,634; a rotating microlens array, as described in U.S. Pat. No. 6,081,381; and a frequencycell array, as described in U.S. Pat. No. 5,453,814.

In the present disclosure, spatial and temporal coherence reducing techniques may be combined for elimination of speckle. A rotating surface relief phase element is used for producing incoherence in the projected laser light. It is a random, nonstructure, which can be thought of as comprising randomized micro lenses. It can also be regarded as a random phase modulator with a relatively high transmittance (e.g., about 90%), as well as a light homogenization diffuser in the present applications. In other embodiments, a high speed liquid crystal phase modulator or electrophase array modulator may be used for making the laser light incoherent. Furthermore, the present disclosure provides a fiber bundle combiner, a fly's eye array/condenser, and fiber conduits or fiber taper combiner, as discussed in greater detail below.

Referring now to FIG. 3, according to one embodiment of the present invention, the incoherence apparatus 56 includes a completely random, non-periodic structure 80 that has a rough surface 82 with random structure bumps 84, 86, 88, . . . that are of random size and thickness. The feature size of each bump, however, is of a magnitude of the desired light wavelength. It is understood that the desired light wavelength may be different for different applications, as is well understood in the art. The phase of input light 90 is thereby modified so that an output light 92 has a wavefront 94 that has a random phase, thereby reducing the speckling of the output light 92. The random wavefront 94 reduces spatial coherence because the phase of the output light 92 is randomly modulated. The structure 80 may be an optical or computer generated phase hologram device or a diffractive optical element with random phase modulation. In some embodiments, it may be a Light Diffusers brand device from Physical Optics Corporation.

The incoherence apparatus 56 also includes a rotational device 96 for rotating the structure 80 in a direction 98. The structure 80 is rotated at a speed that depends on parameters of partial coherent laser array 52, as is well known in the art. A Köhler's illumination configuration may be used to get uniform illumination for a mask or spatial light modulation device. The effect of the randomized wavefront 94 and the rotation 98 reduces temporal coherence because the wavefront 94 is constantly changing. This produces a homogenized light with speckle elimination.

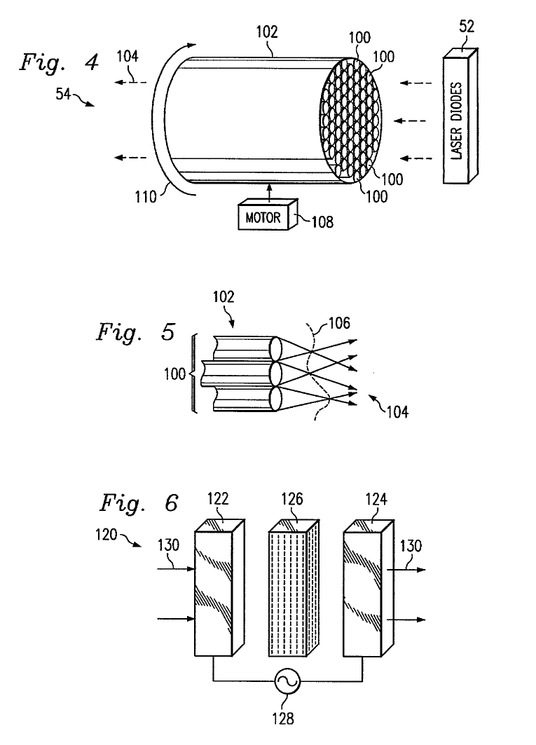

Referring now to FIGS. 4 and 5, in one embodiment of the present invention, the combiner 54 couples the light from the laser diode array 52 into a fiber conduit 102. The fiber conduit 102, which comprises many multi-mode fiber cores 100, may have a relatively large numeric aperture and may be utilized to combine the light power from the laser diode array 52. The fiber conduit 102 emits a light beam 104 that is a partially coherent light source with a phase random modulation wavefront 106. The random wavefront 106 reduces spatial coherence and hence reduces the speckling of the light beam 104.

In some embodiments, the combiner 54 also includes a rotational device 108 for rotating the fiber conduit 102 in a direction 110. This reduces temporal coherence because the random wavefront 106 is constantly changing. Referring also to FIG. 3, in other embodiments, the rotating surface relief phase structure 80 may be placed behind the fiber conduit 102 to convert partially coherent light into incoherent light.

Referring now to FIG. 6, in another embodiment, the incoherence apparatus 56 modulates the phase of the light from the laser diodes 52 by using a liquid crystal device 120. The liquid crystal device 120 includes two transparent electrodes 122, 124 and a liquid crystal medium 126. The electrodes are connected to a high frequency voltage source 128. As light 130 passes through the electrodes 122, 124 and the liquid crystal media 126, the phase of the light is modified by randomly changing the index of refraction (which changes with the random voltage) for the liquid crystal, thereby reducing temporal coherence. It is noted that the speckle is reduced over time due to the ever changing phase of the light. An advantage of the present embodiment is that it does not require mechanical movement.

According to another embodiment, a fly's eye array and condenser lens can be used to combine the light power of the laser diodes of the laser diode array 52. A fly's eye array may be used as a coupling lens for the laser diode array, and a light shaping array can be used for shaping the light beam from each laser diode to get a round distribution light beam. The fly's eye array will focus the light beam from each laser diode at the front focal plane of a condenser. The light power will combine at the back focal plane of the condenser. A speckle eliminator can be placed nearby this position to convert the partial coherent light into incoherent uniform light, which may then be expanded by a light illuminator to illuminate the wafer.

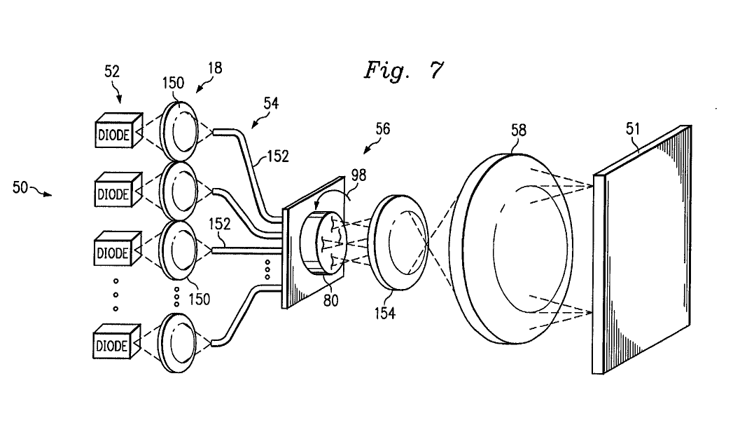

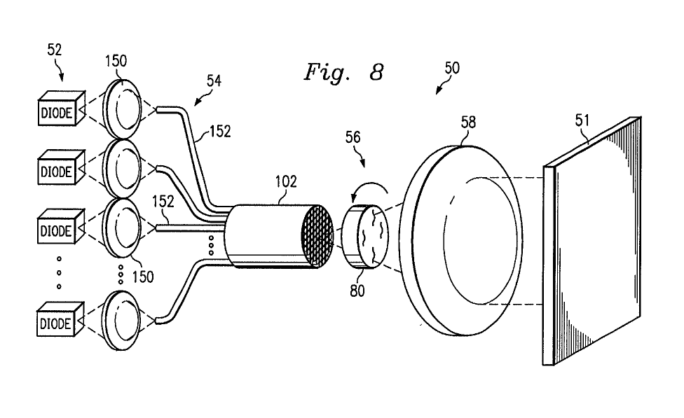

Referring now to FIG. 7, in one embodiment, the light source 50 has each diode of the laser array source 52 feed into an individual microlens 150 of a microlens array 18. Each microlens 150 is further associated with a fiber 152 and may serve to couple a diode to a fiber 152. The fibers 152 are further directed to operate as the combiner 54. The fiber 152 may be single core or multi-core. The output of the combiner 54 is provided to the incoherence apparatus 56, which in the present embodiment is the rotating surface relief phase structure 80 (FIG. 3) with high transmittance. The output from the incoherence apparatus 56 is then fed into the illuminator 58, which in the present embodiment is a Köhler's illumination system. The Köhler's illumination system is used to get uniform illumination from this incoherent light source for a mask or a spatial light modulation device for focusing on the illumination plane 51. A lens 154 may be used to focus the light on the illuminator 58.

Referring now to FIG. 8, in another embodiment, the light source 50 of FIG. 7 may be modified so that the combiner 54 utilizes the fiber conduit 102 of FIG. 4.

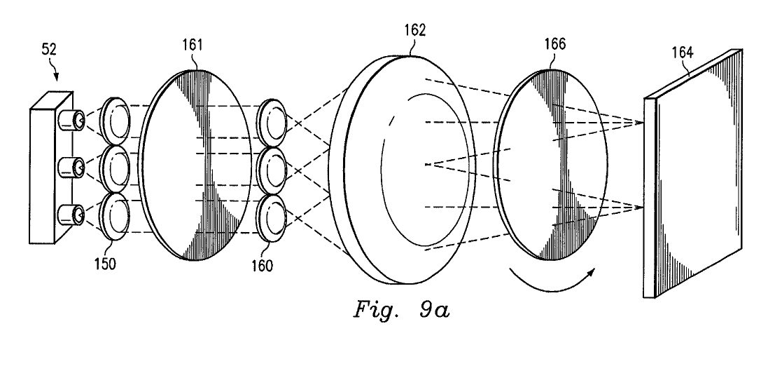

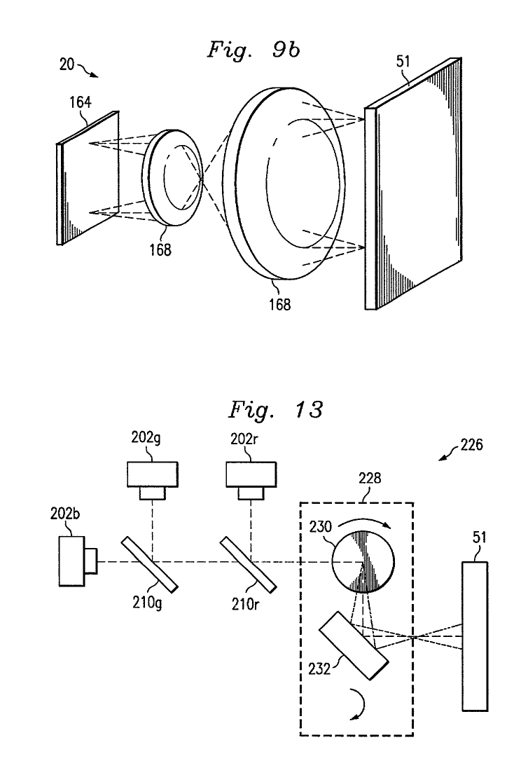

Referring now to FIGS. 9a-9b, in another embodiment, the laser array source 52 may feed into a micro lens array 150, which may collimate the projected light before passing it to a shaping diffuser 161. The shaping diffuser array 161 helps to conform the elliptical output of the laser array source 52 into a more circular shape and also facilitates light homogenization to reduce laser speckle. For example, the diffuser array 161 may be a Light Shaping Diffuser brand device from the Physical Optics Corporation. The light then passes through a fly's eye array 160 and into a condenser 162 that focuses the light towards a focus plane 164, which may correspond with the image source 14 (FIG. 1). An incoherence apparatus 166 may be used to further reduce any speckling. The light then passes through the lens 20, which in the present embodiment includes a tele-centric illumination system 168 for altering the size of the illumination plane 51.

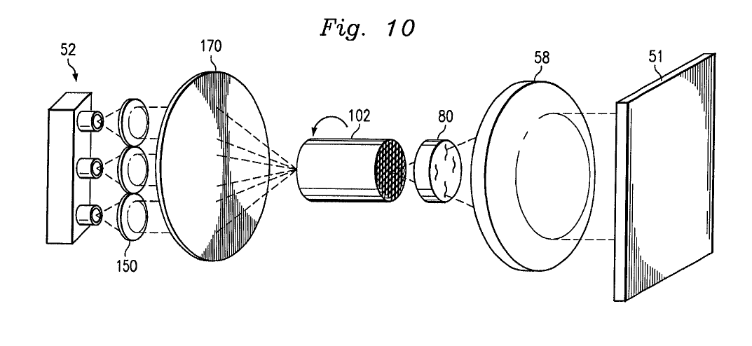

Referring now to FIG. 10, in another embodiment, the light is fed through micro lenses 150 and a focus lens 170, into a rotating fiber conduit 102, and then into a diffuser 80. A light shaping diffuser array 161 (not shown) may be used to further focus the light into the fiber conduit 102. The diffuser 80 may not be required, but may make the light intensity more uniform on an illumination plane 51. The light passes from the diffuser 80, through an illuminator 58, and onto the illumination plane 51.

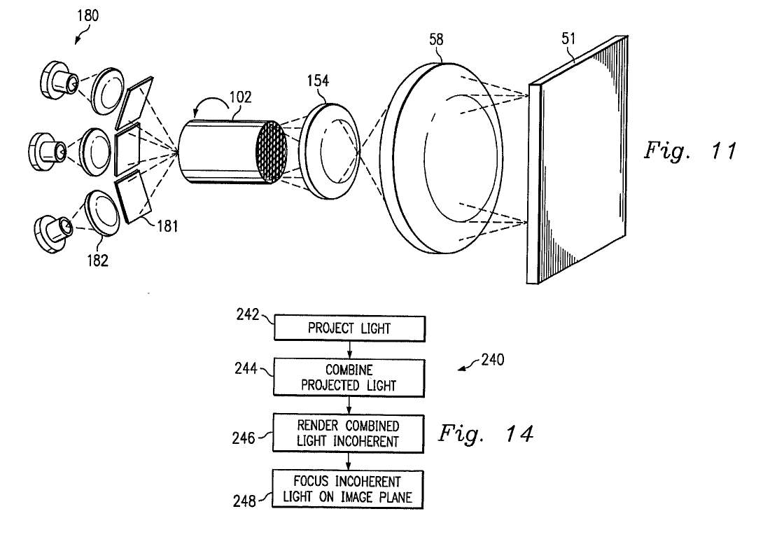

Referring now to FIG. 11, in another embodiment, light from laser diodes (herein designated with numeral 180) is directed towards a central point of a fiber conduit 102. After being projected by the laser diodes 180, the light passes through a lens array 181 into the rotating fiber conduit 102. If desired, a light shaping diffuser 182 can be used to further focus the light towards the fiber conduit 102. The light passes through a lens 154, which directs the light towards an illuminator 58. As described previously, the illuminator 58 then directs the light towards an illumination plane 51.

For applications such as digital photolithography, where the image source 14 of FIG. 1 is a pixel panel such as a DMD or LCD, the laser diode system discussed above may provide many advantages. For example, it may have higher energy efficiency in a pulse operation mode. Furthermore, it may have better energy stability and flexible exposure time control over a broad driving frequency range, as well as higher exposure contrast. It may also provide better resolution.

As for providing better resolution, a laser diode is able to pulse at an extremely high frequency (e.g., in the GHz range). In this way, when a mirror of the DMD moves from one position to the next, the mirror ON/OFF can be synchronized with the pulsing of the diode. Therefore, since light can be effectively “shuttered” off during the mirror transition, diffracted and scattered light is reduced. In addition, a smaller light source (as compared to a conventional Mercury arc lamp) improves the resolution by reducing the spot distortion at the focal point of the micro-lens array.

As for providing higher exposure contrast, individual diodes may be selectively pulsed on and off to accommodate for the desired contrast level. In this way, if certain pixels of the pixel panel are “dull,” more light can be provided to these pixels, than to other less-dull pixels. This can also solve other problems that affect the contrast level.

As a special application, the laser diode array source may have many merits when it is applied to DMD maskless exposure systems. For example, the laser diode array source may provide a narrow spectral width for high resolution projection lens design and a small light source for decreasing focal spot distortion in a point array system. In addition, the laser diode array source may provide higher energy (from a pulsed laser), flexible exposure time control apart from mirror motion, and contrast and resolution improvements from flexible laser power control.

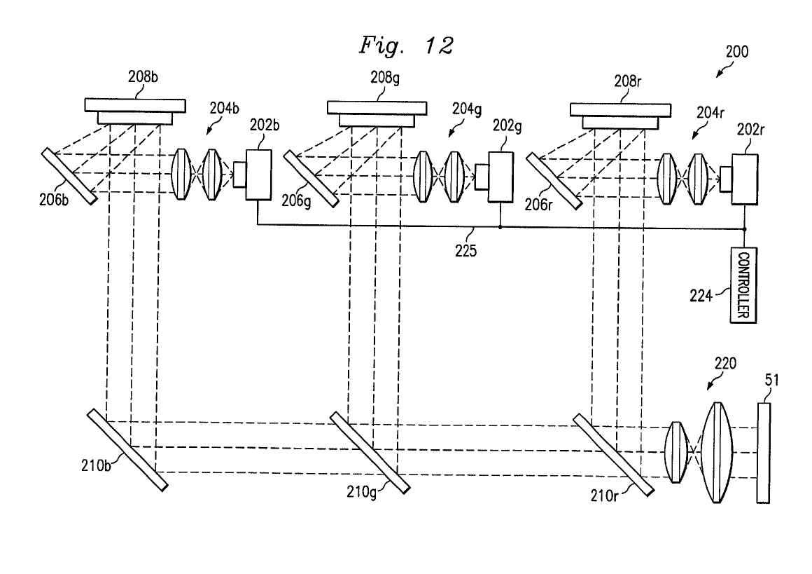

Referring now to FIG. 12, a laser diode display system 200 can utilize one or more of the embodiments discussed above. In one embodiment, the system 200 includes three laser diode sources, a blue/violet laser diode 202b, a green laser diode 202g, and a red laser diode 202r. Each of the diodes 202b, 202g, 202r projects a blue, green, or red light, through a lens system 204b, 204g, 204r, off a mirror 206b, 206g, 206r, and onto a pixel panel (e.g., a DMD) 208b, 208g, 208r, respectively. Each of the DMDs 208b, 208g, 208r reflect a pattern image onto dichroic mirrors/beam splitters 210b, 210g, 210r, respectively, which combine the images. For example, the mirrors 210b, 210g, 210r may enable light to pass from through each mirror in one direction, but may reflect light striking the mirror from another direction. The combined image is then passed through a lens system 220 and onto an illumination plane 51, which may be in the form of a display screen. In some embodiments, the pulsing of the diodes 202 is individually controlled by a controller 224 via a communication bus 225.

Referring now to FIG. 13, in an alternative laser diode display system 226, the pixel panels 208 of the system 200 (FIG. 12) may not be required. In the system 226, the laser diodes 202b, 202g, 202r project a blue, green, and red light stream, respectively, each pulsed at a different phase or frequency. The light streams are provided directly to the dichroic mirrors/beam splitters 210g, 210r, which combine the different colored lights. The combined lights are then provided to a raster scanning mechanism 228. The mechanism 228 includes two axial rotating mirror assemblies 230, 232 to direct the combined light towards the display screen 51 in a raster-scan manner. The mirror assemblies 230, 232 can be synchronized with the pulsing/frequency of the blue, green, and red lights to individually direct certain lights in certain directions.

Alternatively, the pulsing of the blue, green, and red lights can be synchronized by the lasers 202b, 202g, 202r, respectively, so that the proper combination of lights appears on the display screen 51. In this alternative, the mirror assemblies do not have to be individually moved for each light color.

Referring now to FIG. 14, a method 240 illustrates a number of exemplary steps 242-248 by which a high power light source may be implemented in the previously described embodiments. In step 242, one or more light sources may project light. The light projected by multiple light sources is combined in step 244 and rendered incoherent in step 246. In step 248, the incoherent light is focused on an image plane. Various other steps may be included in the method 240. For example, the light sources may be pulsed by a controller. Furthermore, each step 242-248 may include a plurality of substeps that are not illustrated. For example, rendering the combined light incoherent in step 246 may include rotating an incoherence device.

While the invention has been particularly shown and described with reference to the preferred embodiment thereof, it will be understood by those skilled in the art that various changes in form and detail may be made therein without departing form the spirit and scope of the invention. Therefore, the claims should be interpreted in a broad manner, consistent with the present invention.

1. A light source comprising:
a diode array for producing one or more individual laser lights, the diode array including at least one diode;
a combiner for combining the one or more laser lights;
an incoherence apparatus for rendering the combined laser light incoherent; and
an illuminator apparatus for focusing the incoherent combined light onto an image plane.

2. The light source of claim 1 further comprising a pulse source for pulsing the diodes of the diode array at a high frequency.

3. The light source of claim 1 wherein the diode array is a single laser diode.

4. The light source of claim 1 wherein the combiner includes an optical system comprising a fly's eye array and a condenser.

5. The light source of claim 1 wherein the combiner includes a fiber conduit.

6. The light source of claim 1 wherein the incoherence apparatus includes a rotating surface relief phase device.

7. The light source of claim 6 wherein the rotating surface relief phase device is selected from the group consisting of an optical hologram, a computer generated hologram, and a diffractive optical element with random phase modulation.

8. The light source of claim 1 wherein the incoherence apparatus includes a rotating fiber conduit comprising a plurality of multifiber cores.

9. The light source of claim 1 wherein the incoherence apparatus includes a liquid crystal device with random phase modulation.

10. A projection system comprising:
a light source including a diode array for producing one or more individual laser lights;
a combiner for combining the one or more laser lights;
a incoherence apparatus for rendering the combined laser light incoherent;
an illuminator apparatus for focusing the incoherent combined light onto an image plane;
a digital pixel panel for providing a sequence of digital mask images; and
a pulse source for pulsing the diodes of the diode array at a relatively high frequency in synchronism with the sequence of digital mask images.

11. The projection system of claim 10 wherein the digital pixel panel is a deformable mirror device.

12. The projection system of claim 10 wherein the digital pixel panel is a liquid crystal display.

13. The projection system of claim 10 wherein the pulse source further comprises an individual pixel pulsing system for selectively pulsing one or more individual pixels of the digital pixel panel to accommodate an overall contrast of the projection system.

14. The projection system of claim 10 wherein the pulse source further comprises a control board to synchronize a laser diode pulse with a frame rate of the pixel panel to increase the contrast and resolution of an exposed pattern.

15. A display system comprising:
three diode light sources for producing three different colored lights;
a combiner for combining the three different colored lights and directing the combined light towards an image plane;
a controller for pulsing the three diode light sources to produce a colored image at the image plane.

16. The display system of claim 15 wherein the combiner includes at least a first mirror and a second mirror, and wherein each of the first and second mirrors are associated with one of the three diode light sources.

17. The display system of claim 15 further including a raster scanning mechanism operable to direct the combined light towards the image plane.

18. The display system of claim 17 wherein the raster scanning mechanism includes two axial rotating mirror assemblies.

19. The display system of claim 15 wherein the diode light sources are laser diodes.

20. A method for projecting incoherent light, the method comprising:
projecting light from at least one light source;
combining the light from the at least one light source;
rendering the combined light incoherent; and
focusing the incoherent combined light onto an image plane.

21. The method of claim 20 further including pulsing the light source at a high frequency.

22. The method of claim 20 wherein rendering the combined light incoherent includes rotating at least a portion of an incoherence device.

23. The method of claim 20 further including transferring the light through a fiber conduit.

24. The method of claim 20 further including reflecting at least a portion of the projected light from a mirror.
